(19) United States
(12) Patent Application Publication
(10) Pub. No.: US 2025/0192818 A1
(43) Pub. Date: Jun. 12, 2025

(54) SYSTEM AND METHOD FOR TRANSMITTING DATA IN A WIRELESS COMMUNICATION NETWORK

(71) Applicant: Elbit Systems C4I and Cyber Ltd., Netanya (IL)

(72) Inventors: Yizhack YADGAR, Netanya (IL); Lior SHADHAN, Netanya (IL)

(21) Appl. No.: 19/054,962

(22) Filed: Feb. 17, 2025

Related U.S. Application Data
(63) Continuation of application No. PCT/IL2023/051083, filed on Oct. 17, 2023.

(30) Foreign Application Priority Data
Oct. 18, 2022 (IL) 297394

(51) Int. Cl. H04B 1/7143; H04W 72/0446

(52) U.S. Cl. CPC H04B 1/7143; H04W 72/0446

(57) ABSTRACT

A method for transmitting data in a wireless communication network with at least one radio frequency channel, the method comprising: transmitting the data over the at least one radio frequency channel in a sequence of a predetermined number of timeslots, wherein: (a) two or more users of the network share the given radio frequency channel and a given timeslot, (b) the data from the users is transmitted in the network using frequency hopping in which each of the users has a frequency hopping sequence, (c) the data of each user sharing the given timeslot in the given radio frequency channel is transmitted in a sub-channel of the given timeslot that is substantially orthogonal to other sub-channels of the given timeslot, and (d) the given timeslot includes a guard time sub-channel that is: (i) substantially orthogonal to other sub-channels of the given timeslot, (ii) located at the end of the given timeslot, (iii) not used to transmit the data from the users, and (iv) shared between the users, thereby enabling a receiver, receiving the data transmitted over the at least one radio frequency channel after propagation delay causing one or more of the sub-channels of the given timeslot to at least partly superimpose, to separate the one or more at least partly superimposed sub-channels by using the guard time sub-channel and utilizing a non-orthogonal access method.

### TECHNICAL FIELD

The invention relates to a system and method for transmitting data in a wireless communication network.

### BACKGROUND

Users of a communication network can share the same frequency channel by dividing the signal into different timeslots. For example, by using the Time-division multiple access (TDMA) channel access method. In some cases, frequency hopping is utilized as part of the usage of the communication network. In these cases, the users transmitting radio signals rapidly change the carrier frequency among many distinct frequencies occupying a large spectral band. The receiving users change the receiving frequencies according to the same frequency hopping sequence the transmitting user uses. The changes are controlled by a sequence code known to both transmitting and receiving users.

One of the challenges of communication networks is propagation delay—the amount of time it takes for the head of the signal to travel from the transmitting user to the receiving user. Propagation delay can be computed as the ratio between the link length and the propagation speed over the specific medium. As a result of the distance between the location of the transmitting user to the location of the receiving user, propagation delay causes a signal transmitted in a given timeslot signal to overflow and be received by the receiving user as at least partly superimposing on a subsequent timeslot. Current solutions use a guard time for each of the transmitting users—part of the timeslot is not used for transmitting and receiving signals. The guard time guards from the overflow caused by propagation delay as it is transmitted within the guard time and does not superimpose on the signal transmitted in the subsequent timeslot.

This solution is wasteful. The guard time is an overhead on the communication network as signals cannot be transmitted during the guard time, thus the overall bandwidth of the network diminishes.

There is thus a need in the art for a new method and system for transmitting data in a wireless communication network that will allow multiple users to share a single guard time within a given timeslot. In a frequency hopping communication network this will allow for fast frequency hopping, as each user transmits his data within each of the shared timeslots without the need to wait for an unreserved timeslot.

### GENERAL DESCRIPTION

In accordance with a first aspect of the presently disclosed subject matter, there is provided a method for transmitting data in a wireless communication network with at least one radio frequency channel, the method comprising: transmitting the data over the at least one radio frequency channel in a sequence of a predetermined number of timeslots, wherein: (a) two or more users of the network share the given radio frequency channel and a given timeslot, (b) the data from the users is transmitted in the network using frequency hopping in which each of the users has a frequency hopping sequence, (c) the data of each user sharing the given timeslot in the given radio frequency channel is transmitted in a sub-channel of the given timeslot that is substantially orthogonal to other sub-channels of the given timeslot, and (d) the given timeslot includes a guard time sub-channel that is: (i) substantially orthogonal to other sub-channels of the given timeslot, (ii) located at the end of the given timeslot, (iii) not used to transmit the data from the users, and (iv) shared between the users, thereby enabling a receiver, receiving the data transmitted over the at least one radio frequency channel after propagation delay causing one or more of the sub-channels of the given timeslot to at least partly superimpose, to separate the one or more at least partly superimposed sub-channels by using the guard time sub-channel and utilizing a non-orthogonal access method.

In some cases, (a) a first sub-channel of the sub-channels of the given timeslot in the given radio frequency channel is used simultaneously to transmit data of two or more first sharing users of the users, and (b) a second sub-channel of the sub-channels of the given timeslot in the given radio frequency channel is used simultaneously to transmit data of two or more second sharing users of the users; and upon the first sharing users and the second sharing users transmitting data in a second timeslot in a second radio frequency channel, subsequent to the given timeslot, a third sub-channel of the sub-channels of the second timeslot is used at the same time to transmit data of two or more third sharing users of the or more users, and a fourth sub-channel of the sub-channels of the second timeslot is used at the same time to transmit data of two or more fourth sharing users of the users, wherein the third sharing users comprises at least a first user from the first sharing users and a first user from the second sharing users and the fourth sharing users comprises at least a second user from the first sharing users and a second user from the second sharing users.

In some cases, the frequency of the given radio frequency channel is different from the frequency of the second radio frequency channel.

In some cases, the non-orthogonal access method is a Non-Orthogonal Multiple Access (NOMA) method.

In some cases, the transmitting of the data over the at least one radio frequency channel in a sequence of a predetermined number of timeslots utilizes the Time-Division Multiple Access (TDMA) channel access method.

In some cases, each of the users is associated with a distinct frequency hopping sequence.

In some cases, a radio communication device comprising a transmitter, capable of transmitting data in accordance with the method.

In some cases, a radio communication device comprising a receiver, capable of receiving data transmitted in accordance with the method.

In accordance with a second aspect of the presently disclosed subject matter, there is provided a method for transmitting data in a wireless communication network with at least one radio frequency channel, the method comprising: transmitting the data over the at least one radio frequency channel in a sequence of a predetermined number of timeslots, wherein: (a) a first user of the network transmits data using a first timeslot, and (b) a second user of the network transmits data using a second timeslot, wherein the second timeslot is subsequent to the first timeslot, thereby enabling a receiver, receiving the data transmitted over the at least one radio frequency channel after propagation delay causing the first timeslot to at least partly superimpose on the second timeslot, to separate the at least partly superimposed timeslots by utilizing a non-orthogonal access method.

In some cases, the non-orthogonal access method is a Non-Orthogonal Multiple Access (NOMA) method.

In some cases, the transmitting of the data over the at least one radio frequency channel in a sequence of a predetermined number of timeslots utilizes the Time-Division Multiple Access (TDMA) channel access method.

In some cases, a radio communication device comprising a transmitter, capable of transmitting data in accordance with the method.

In some cases, a radio communication device comprising a receiver, capable of receiving data transmitted in accordance with the method.

In accordance with a third aspect of the presently disclosed subject matter, there is provided a system for transmitting data in a wireless communication network with at least one radio frequency channel, the system comprising a processing circuitry configured to: transmit the data over the at least one radio frequency channel in a sequence of a predetermined number of timeslots, wherein: (a) two or more users of the network share the given radio frequency channel and a given timeslot, (b) the data from the users is transmitted in the network using frequency hopping in which each of the users has a frequency hopping sequence, (c) the data of each user sharing the given timeslot in the given radio frequency channel is transmitted in a sub-channel of the given timeslot that is substantially orthogonal to other sub-channels of the given timeslot, and (d) the given timeslot includes a guard time sub-channel that is: (i) substantially orthogonal to other sub-channels of the given timeslot, (ii) located at the end of the given timeslot, (iii) not used to transmit the data from the users, and (iv) shared between the users, thereby enabling a receiver, receiving the data transmitted over the at least one radio frequency channel after propagation delay causing one or more of the sub-channels of the given timeslot to at least partly superimpose, to separate the one or more at least partly superimposed sub-channels by using the guard time sub-channel and utilizing a non-orthogonal access method.

In some cases, (a) a first sub-channel of the sub-channels of the given timeslot in the given radio frequency channel is used simultaneously to transmit data of two or more first sharing users of the users, and (b) a second sub-channel of the sub-channels of the given timeslot in the given radio frequency channel is used simultaneously to transmit data of two or more second sharing users of the users; and upon the first sharing users and the second sharing users transmitting data in a second timeslot in a second radio frequency channel, subsequent to the given timeslot, a third sub-channel of the sub-channels of the second timeslot is used at the same time to transmit data of two or more third sharing users of the or more users, and a fourth sub-channel of the sub-channels of the second timeslot is used at the same time to transmit data of two or more fourth sharing users of the users, wherein the third sharing users comprises at least a first user from the first sharing users and a first user from the second sharing users and the fourth sharing users comprises at least a second user from the first sharing users and a second user from the second sharing users.

In some cases, the frequency of the given radio frequency channel is different from the frequency of the second radio frequency channel.

In some cases, the non-orthogonal access method is a Non-Orthogonal Multiple Access (NOMA) method.

In some cases, the transmitting of the data over the at least one radio frequency channel in a sequence of a predetermined number of timeslots utilizes the Time-Division Multiple Access (TDMA) channel access method.

In some cases, each of the users is associated with a distinct frequency hopping sequence.

In accordance with a fourth aspect of the presently disclosed subject matter, there is provided a system for transmitting data in a wireless communication network with at least one radio frequency channel, the method comprising a processing circuity configured to: transmit the data over the at least one radio frequency channel in a sequence of a predetermined number of timeslots, wherein: (a) a first user of the network transmits data using a first timeslot, and (b) a second user of the network transmits data using a second timeslot, wherein the second timeslot is subsequent to the first timeslot, thereby enabling a receiver, receiving the data transmitted over the at least one radio frequency channel after propagation delay causing the first timeslot to at least partly superimpose on the second timeslot, to separate the at least partly superimposed timeslots by utilizing a non-orthogonal access method.

In some cases, the non-orthogonal access method is a Non-Orthogonal Multiple Access (NOMA) method.

In some cases, the transmitting of the data over the at least one radio frequency channel in a sequence of a predetermined number of timeslots utilizes the Time-Division Multiple Access (TDMA) channel access method.

In accordance with a fifth aspect of the presently disclosed subject matter, there is provided a non-transitory computer readable storage medium having computer readable program code embodied therewith, the computer readable program code, executable by at least one processing circuitry of a computer to perform a method for transmitting data in a wireless communication network with at least one radio frequency channel, the method comprising: transmitting the data over the at least one radio frequency channel in a sequence of a predetermined number of timeslots, wherein: (a) two or more users of the network share the given radio frequency channel and a given timeslot, (b) the data from the users is transmitted in the network using frequency hopping in which each of the users has a frequency hopping sequence, (c) the data of each user sharing the given timeslot in the given radio frequency channel is transmitted in a sub-channel of the given timeslot that is substantially orthogonal to other sub-channels of the given timeslot, and (d) the given timeslot includes a guard time sub-channel that is: (i) substantially orthogonal to other sub-channels of the given timeslot, (ii) located at the end of the given timeslot, (iii) not used to transmit the data from the users, and (iv) shared between the users, thereby enabling a receiver, receiving the data transmitted over the at least one radio frequency channel after propagation delay causing one or more of the sub-channels of the given timeslot to at least partly superimpose, to separate the one or more at least partly superimposed sub-channels by using the guard time sub-channel and utilizing a non-orthogonal access method.

In accordance with a sixth aspect of the presently disclosed subject matter, there is provided a non-transitory computer readable storage medium having computer readable program code embodied therewith, the computer readable program code, executable by at least one processing circuitry of a computer to perform a method for transmitting data in a wireless communication network with at least one radio frequency channel, the method comprising: transmitting the data over the at least one radio frequency channel in a sequence of a predetermined number of timeslots, wherein: (a) a first user of the network transmits data using a first timeslot, and (b) a second user of the network transmits data using a second timeslot, wherein the second timeslot is subsequent to the first timeslot, thereby enabling a receiver, receiving the data transmitted over the at least one radio frequency channel after propagation delay causing the first timeslot to at least partly superimpose on the second timeslot, to separate the at least partly superimposed timeslots by utilizing a non-orthogonal access method.

### BRIEF DESCRIPTION OF THE DRAWINGS

In order to understand the presently disclosed subject matter and to see how it may be carried out in practice, the subject matter will now be described, by way of non-limiting examples only, with reference to the accompanying drawings, in which:

FIG. 1A is a schematic illustration of an example of users transmitting data over timeslots with a shared guard time, in accordance with the presently disclosed subject matter;

FIG. 1B is a schematic illustration of an example of the impact of propagation delay on the receiving of the data transmitted by the users over timeslots with a shared guard time, in accordance with the presently disclosed subject matter;

FIG. 1C is a schematic illustration of an example of users transmitting data over timeslots with a shared guard time with two or more users using a given sub-channel of the timeslot simultaneously, in accordance with the presently disclosed subject matter;

FIG. 1D is a schematic illustration of an example of the impact of propagation delay on the receiving of the data transmitted by the users over timeslots with a shared guard time where two or more users are using a given sub-channel of the timeslot simultaneously, in accordance with the presently disclosed subject matter;

FIG. 1E is a schematic illustration of an example of users transmitting data over timeslots with no guard time and no frequency hopping, in accordance with the presently disclosed subject matter;

FIG. 1F is a schematic illustration of an example of the impact of propagation delay on the receiving of the data transmitted by the users over timeslots with no guard time and no frequency hopping, in accordance with the presently disclosed subject matter;

FIG. 2 is a block diagram schematically illustrating one example of a system for transmitting data in a wireless communication network, in accordance with the presently disclosed subject matter;

FIG. 3 is a flowchart illustrating one example of a sequence of operations carried out for transmitting data in a wireless communication network with shared guard times, in accordance with the presently disclosed subject matter; and

FIG. 4 is a flowchart illustrating one example of a sequence of operations carried out for transmitting data in a wireless communication network with no guard times, in accordance with the presently disclosed subject matter.

### DETAILED DESCRIPTION

In the following detailed description, numerous specific details are set forth in order to provide a thorough understanding of the presently disclosed subject matter. However, it will be understood by those skilled in the art that the presently disclosed subject matter may be practiced without these specific details. In other instances, well-known methods, procedures, and components have not been described in detail so as not to obscure the presently disclosed subject matter.

In the drawings and descriptions set forth, identical reference numerals indicate those components that are common to different embodiments or configurations.

Unless specifically stated otherwise, as apparent from the following discussions, it is appreciated that throughout the specification discussions utilizing terms such as “transmitting”, “receiving”, “determining”, “separating”, “performing”, “updating”, “hopping” or the like, include action and/or processes of a computer that manipulate and/or transform data into other data, said data represented as physical quantities, e.g., such as electronic quantities, and/or said data representing the physical objects. The terms “computer”, “processor”, “processing resource”, “processing circuitry” and “controller” should be expansively construed to cover any kind of electronic device with data processing capabilities, including, by way of non-limiting example, a personal desktop/laptop computer, a server, a computing system, a communication device, a smartphone, a tablet computer, a smart television, a processor (e.g. digital signal processor (DSP), a microcontroller, a field programmable gate array (FPGA), an application specific integrated circuit (ASIC), etc.), a group of multiple physical machines sharing performance of various tasks, virtual servers co-residing on a single physical machine, any other electronic computing device, and/or any combination thereof.

The operations in accordance with the teachings herein may be performed by a computer specially constructed for the desired purposes or by a general-purpose computer specially configured for the desired purpose by a computer program stored in a non-transitory computer readable storage medium. The term “non-transitory” is used herein to exclude transitory, propagating signals, but to otherwise include any volatile or non-volatile computer memory technology suitable to the application.

As used herein, the phrase “for example,” “such as”, “for instance” and variants thereof describe non-limiting embodiments of the presently disclosed subject matter. Reference in the specification to “one case”, “some cases”, “other cases” or variants thereof means that a particular feature, structure or characteristic described in connection with the embodiment(s) is included in at least one embodiment of the presently disclosed subject matter. Thus, the appearance of the phrase “one case”, “some cases”, “other cases” or variants thereof does not necessarily refer to the same embodiment(s).

It is appreciated that, unless specifically stated otherwise, certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

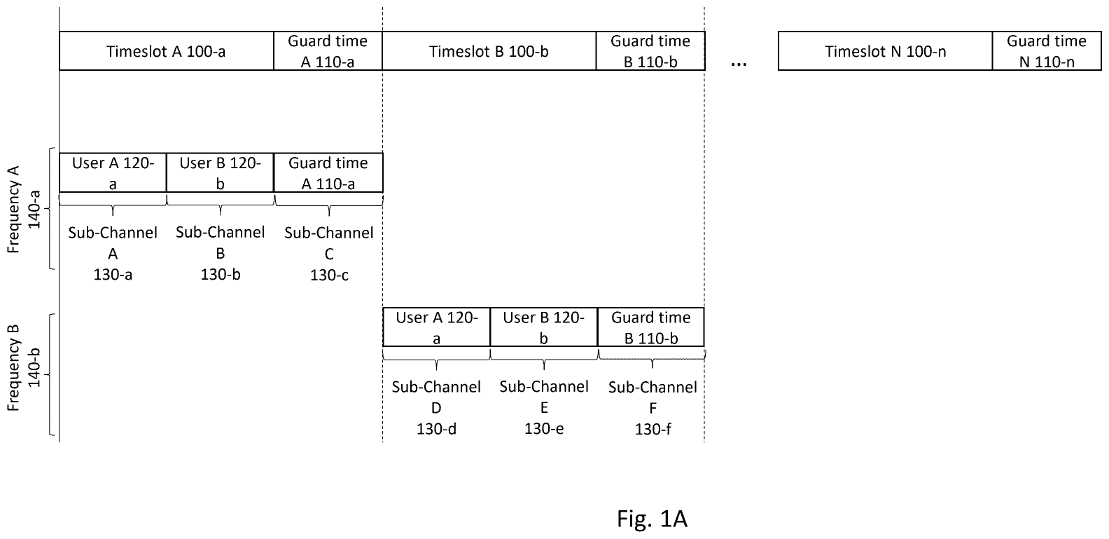

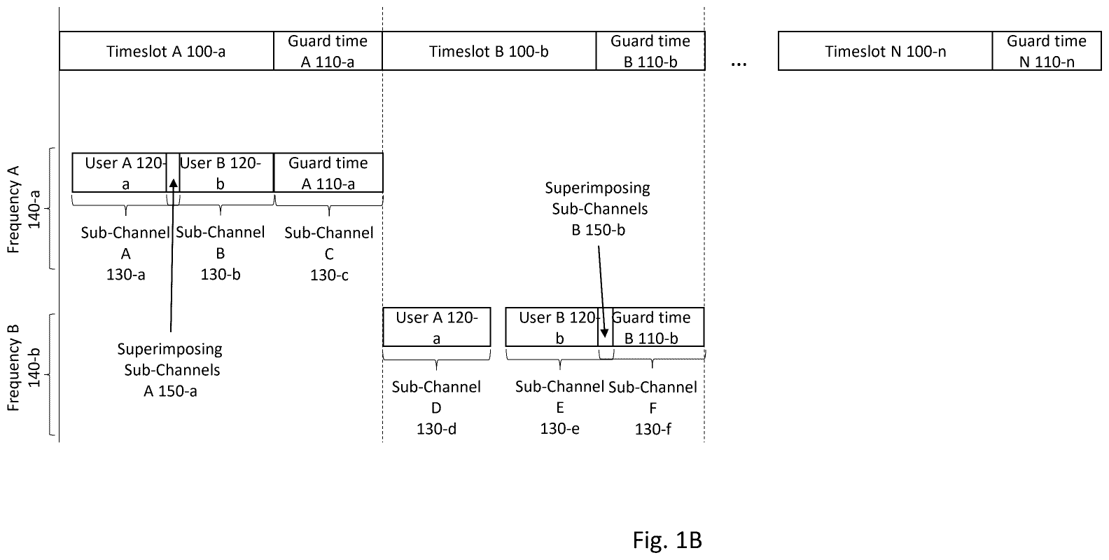

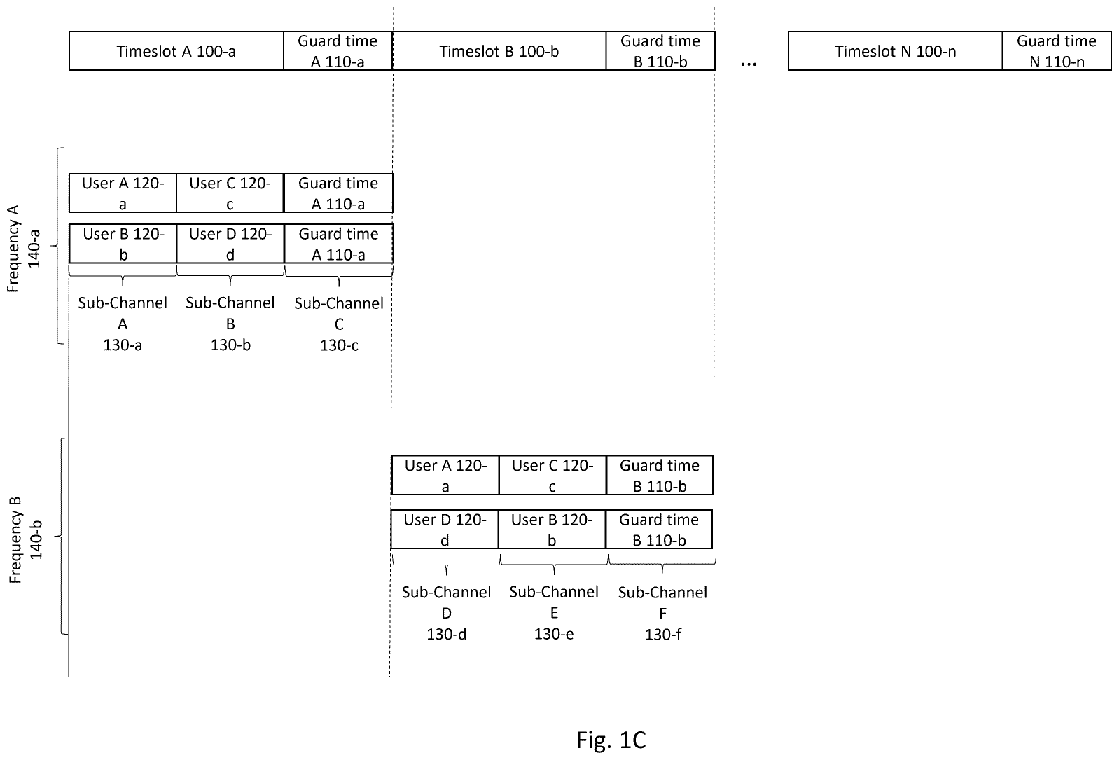

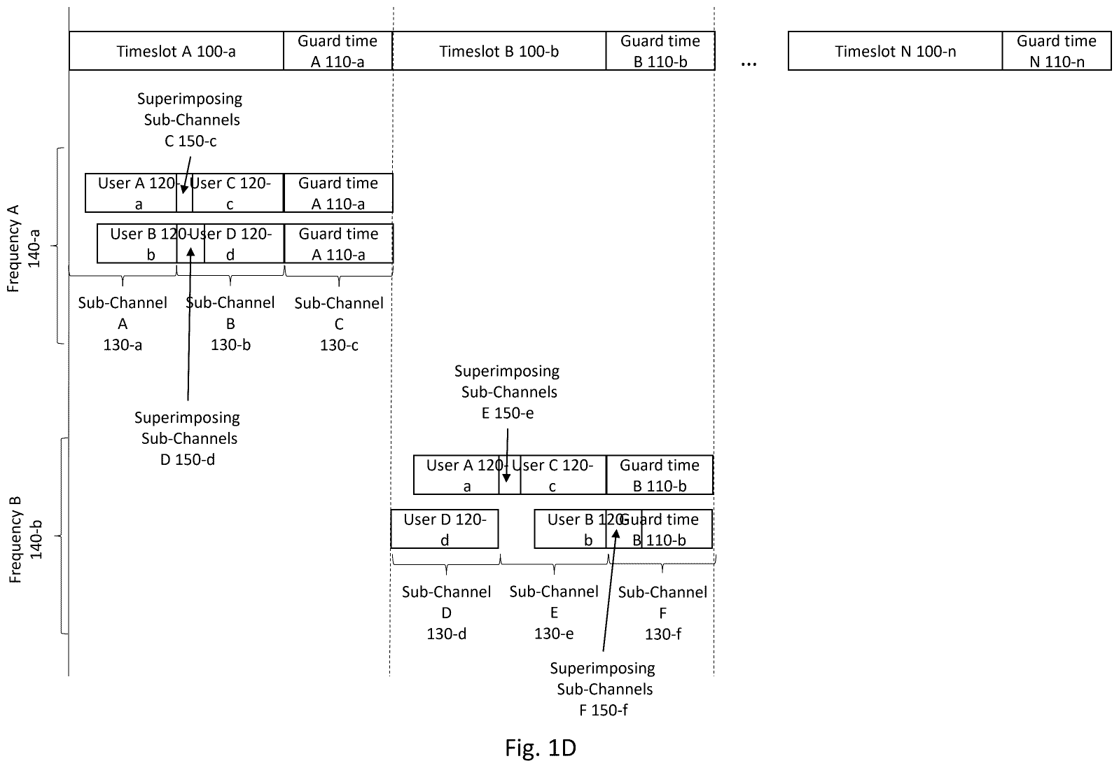

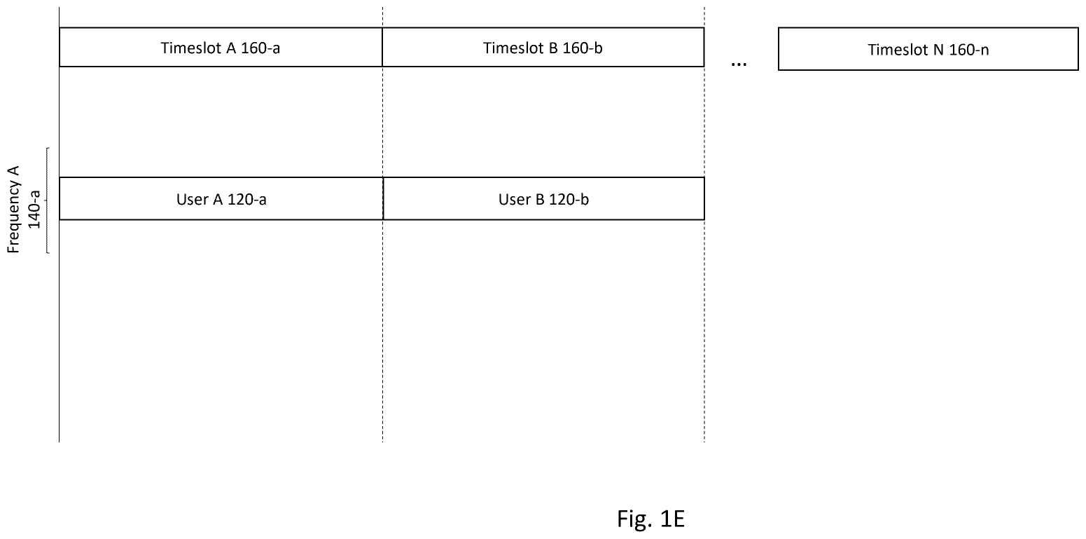

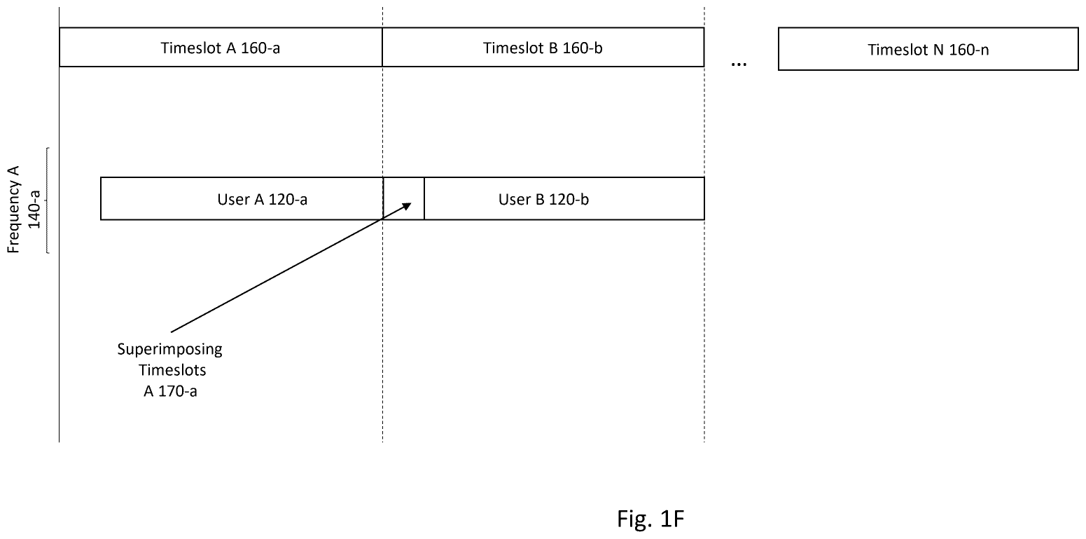

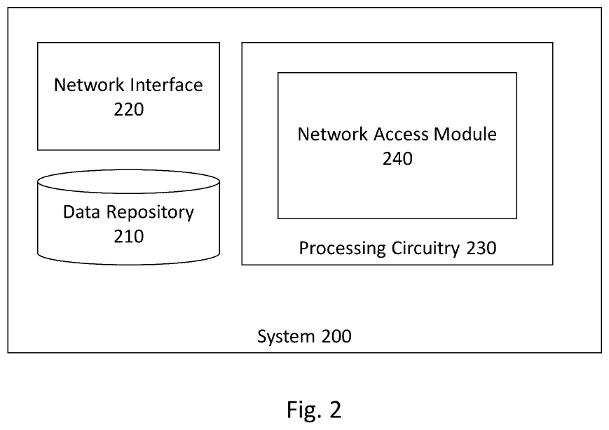

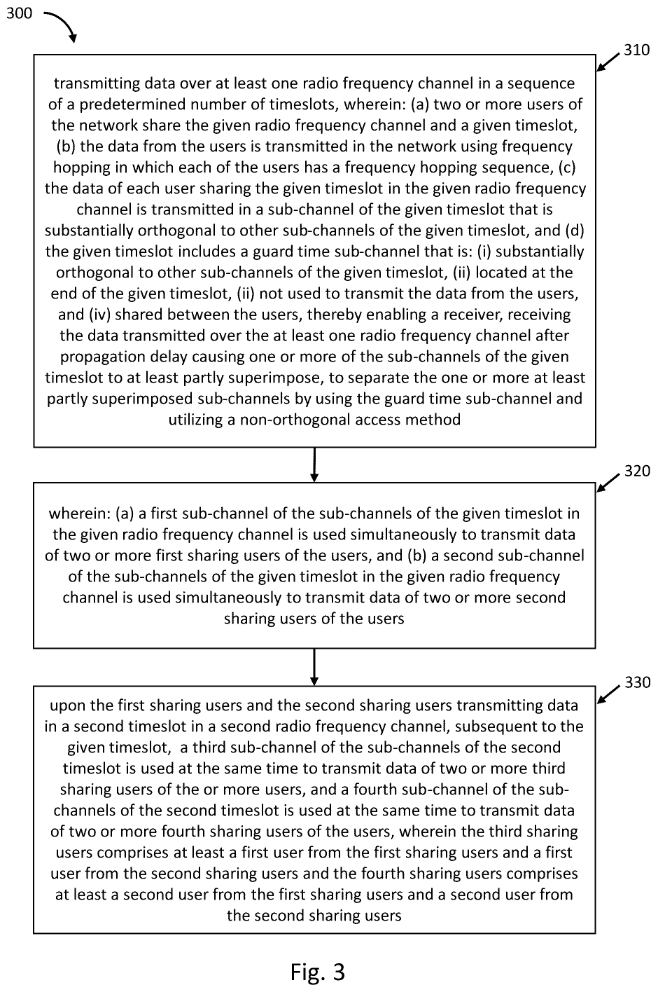

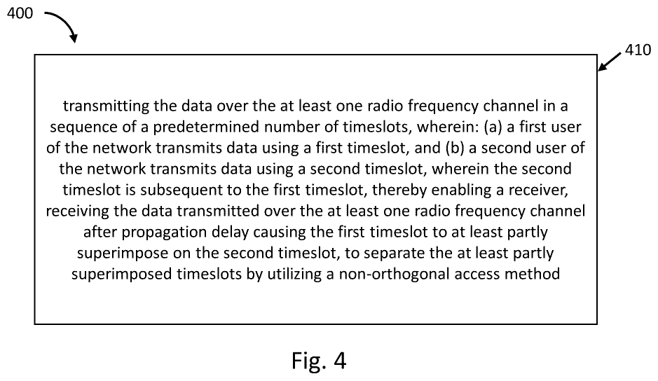

In embodiments of the presently disclosed subject matter, fewer, more and/or different stages than those shown in FIGS. 3-4 may be executed. In embodiments of the presently disclosed subject matter one or more stages illustrated in FIGS. 3-4 may be executed in a different order and/or one or more groups of stages may be executed simultaneously. FIGS. 1A-1F and FIG. 2 illustrate a general schematic of the system architecture in accordance with an embodiment of the presently disclosed subject matter. Each module in FIGS. 1A-1F and FIG. 2 can be made up of any combination of software, hardware and/or firmware that performs the functions as defined and explained herein. The modules in FIGS. 1A-1F and FIG. 2 may be centralized in one location or dispersed over more than one location. In other embodiments of the presently disclosed subject matter, the system may comprise fewer, more, and/or different modules than those shown in FIGS. 1A-1F and FIG. 2.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

Bearing this in mind, attention is drawn to FIG. 1A, a schematic illustration of an example of users transmitting data over timeslots with a shared guard time, in accordance with the presently disclosed subject matter.

Users (for example: user A 120-a, user B 120-b, user C 120-c, user D 120-d) of a communication network, having one or more frequency channels each having a given frequency (for example: frequency A 140-a, frequency B 140-b), can share a given frequency channel by dividing the signal into different timeslots (e.g., timeslot A 100-a, timeslot B 100-b, . . . , timeslot N 100-n). For example, by using the Time-division multiple access (TDMA) channel access method. The timeslots of the given frequency channel can be sequenced in a predetermined number of timeslots.

The communication network can be a radio communication network, where the users transmit and/or receive radio signals. A user can be any device (for example, a transmitter, a receiver, a transceiver, a computerized device with a network interface, etc.) that can transmit and/or receive radio signals from and to the communication network. The radio signals transmitted and/or received can contain voice, video, data or any other information the user transmits or receives from the network.

The system and method for transmitting data in a wireless communication network described herein determines how a given timeslot within the given frequency channel can be used by two or more users. This is achieved by allocating sub-channels (e.g., sub-channel A 130-a, sub-channel B 130-b, sub-channel C 130-c, sub-channel D 130-d, sub-channel E 130-e, sub-channel F 130-f) within the timeslots for the users to transmit and to receive signals. A given sub-channel of the sub-channels is substantially orthogonal in time to the other sub-channels of the given timeslot. The system and method for transmitting data in a wireless communication network can dedicate a distinct receiving and/or transmitting time for each of the users sharing the timeslot by allocating a corresponding sub-channel to each of the users. The timeslot is divided over time between two or more users.

One of the challenges of communication networks is propagation delay—the amount of time it takes for the radio signal to travel from the location of the transmitting user to the location of the receiving user. Propagation delay can be computed as the ratio between the link length and the propagation speed over the specific medium. As a result of the distance between the location of the transmitting user to the location of the receiving user, propagation delay causes a signal transmitted in a given timeslot signal to overflow and be received by the receiving user as at least partly superimposing on a subsequent timeslot. The system and method for transmitting data in a wireless communication network uses a guard time (e.g., guard time A 110-a, guard time B 110-b, . . . , guard time N 110-n) for each of the timeslots. The guard time is a sub-channel that is a part of the timeslot not used for transmitting signals. The guard time is substantially orthogonal to other sub-channels of the given timeslot. The guard time is located at the end of the given timeslot. The guard time is shared between the users—one guard only is commonly used for all the users sharing the given timeslot. The guard time guards from the overflow caused by propagation delay as it is transmitted within the guard time and does not superimpose on the signal transmitted in the subsequent timeslot. In the non-limiting example depicted in FIG. 1A, timeslot A 100-a is transmitted over a first frequency channel having frequency A 140-a. Timeslot A 100-a comprises three orthogonal sub-channels: sub-channel A 130-a, sub-channel B 130-b and sub-channel C 130-c. Timeslot A 100-a is shared between two users in this example: user A 120-a and user B 120-b. The two users share the same timeslot by each using one of the sub-channels: user A 120-a transmits on sub-channel A 130-a and user B 120-b transmits on sub-channel B 130-b. The last sub-channel of timeslot A 100-a is sub-channel C 130-c and it is used for guard time A 110-a. Guard time A 110-a is shared and used commonly by both users: user A 120-a and user B 120-b, so that a transmission by one of the users that overflows into the guard time because of propagation delay can be received without collisions. FIG. 1A, also depicts a subsequent timeslot B 100-b, subsequent to timeslot A 100-a, that is transmitted over a second frequency channel having frequency B 140-b. Timeslot B 100-b comprises three orthogonal sub-channels: sub-channel D 130-d, sub-channel E 130-e and sub-channel F 130-f. Timeslot B 100-b is shared between two users in this example: user A 120-a and user B 120-b. The two users share the same timeslot by each using one of the sub-channels: user A 120-a transmits on sub-channel D 130-d and user B 120-b transmits on sub-channel E 130-e. The last sub-channel of timeslot A 100-a is sub-channel F 130-f and it is used for guard time B 110-b. Guard time B 110-b is shared and used commonly by both users: user A 120-a and user B 120-b.

It is to be noted that in some cases the order of the transmissions by the users within subsequent timeslots can be changed relative to the order of transmissions in previous timeslots. In our non-limiting example, in timeslot B 100-b: user B 120-b can transmit in sub-channel D 130-d and user A 120-a can transmit in sub-channel E 120-e. This results in less collisions between the signals transmitted by the users within the timeslot or in collisions with different user at each timeslot. Collisions with different user at each timeslot are easier to resolve using NOMA.

In some cases, frequency hopping is utilized as part of the usage of the communication network. In these cases, the users transmitting radio signals rapidly change the carrier frequency among many distinct frequencies occupying a large spectral band. The receiving users change the receiving frequencies according to the same frequency hopping sequence the transmitting user uses. The changes are controlled by a sequence code known to both transmitting and receiving users. The frequency hopping sequence can be a given frequency hopping sequence that is used by all the users. In some cases, the users change the frequency hopping sequence they use over time. The users receive at all the hops of the frequency hopping sequence. A user does not have to transmit at each hop of the frequency hopping sequence. In our non-limiting example, user A 120-a and user B 120-b transmit within timeslot A 100-a in frequency A 140-a and subsequently transmit within timeslot B 100-b in frequency B 140-b. In some cases, the users can transmit using different frequency hopping sequences.

FIG. 1B depicts a schematic illustration of an example of the impact of propagation delay on the receiving of the data transmitted by the users over timeslots with a shared guard time, in accordance with the presently disclosed subject matter. FIG. 1B continues our non-limiting example from FIG. 1A, it shows how propagation delay causes a receiving user to receive the signal transmitted by user A 120-a and user B 120-b after a delay. The delay causing one or more of the sub-channels of the given timeslot to at least partly superimpose. In our example, the propagation delay caused sub-channel A 130-a of timeslot A 100-a to superimpose on sub-channel B 130-b of timeslot A 100-a, thereby creating a part of timeslot A 100-a that contains signals from both user A 120-a and user B 120-b. This part is labeled superimposing sub-channels A 150-a. In the same example, the propagation delay has also caused sub-channel E 130-e of timeslot B 100-b to superimpose on sub-channel F 130-f of timeslot B 100-b, thereby creating a part of timeslot B 100-b that contains signals from user B 120-b and user B 120-b that superimpose on the guard time B 110-b. This part is labeled superimposing sub-channels B 150-b. The superimposing sub-channels (for example: superimposing sub-channels A 150-a, superimposing sub-channels B 150-b) are separated by using the guard time sub-channel and utilizing a non-orthogonal access method. In our example, superimposing sub-channels A 150-a contain data transmitted by user A 120-a and user B 120-b. The separation of that superimposing radio signals is achieved utilizing a non-orthogonal access method. An example of a non-orthogonal access method is Non-Orthogonal Multiple Access (NOMA) method. NOMA uses superposition coding at the transmitter side and a decoding method at the receiver side, for example: Multi-User Joint Decoding or Successive Interference Cancellation (SIC) at the receiver side to allow multiple users to utilize the same frequency of the communication network. At the transmitter site, the users' signals are superimposed into a single waveform, while at the receiver, SIC decodes the signals one by one until it finds the desired signal. The first signal that SIC decodes has the strongest power while others are viewed temporarily as interferences. In SIC, for example, the first decoded signal is then subtracted from the received signal and if the decoding is perfect, the waveform with the rest of the signals is accurately obtained. SIC iterates the process until it finds the desired signal. Continuing our example, superimposing sub-channels B 150-b contain data transmitted by user B 120-b only because sub-channel F 130-f is used for guard time B 110-b where no data is transmitted. It is to be noted that in some cases two or more of the received signals can have the same or similar power level. In these cases, one of the received signals with the same or similar power level can be decoded together or before the others. Examples of such algorithms are: Multi users Joint Decoding and Message Passage Algorithm (MPA).

It is to be noted that in some cases the order of the transmissions by the users within subsequent timeslots can be changed relative to the order of transmissions in previous timeslots. In our non-limiting example, in timeslot B 100-b: user B 120-b can transmit in sub-channel D 130-d and user A 120-a can transmit in sub-channel E 120-e. This results in less collisions between the signals transmitted by the users within the timeslot or in collisions with different user at each timeslot. Collisions with different user at each timeslot are easier to resolve using NOMA.

In a frequency hopping communication network, the system and method for transmitting data in a wireless communication network allows for fast frequency hopping, as each user transmits his data in a dedicated sub-channel within each of the shared timeslots without the need to wait for an unreserved timeslot. The guard time is share commonly between the users using the timeslot, thereby minimizing the overhead on the bandwidth of the communication network. The system and method for transmitting data in a wireless communication network that uses orthogonal sub-channels of the timeslot for each user, combines a shared guard time with a non-orthogonal access method to enable two or more users to share a given timeslot without having to waste multiple guard times within the timeslot and enabling a receiver to separate the one or more at least partly superimposed sub-channels by using the guard time sub-channel and utilizing a non-orthogonal access method.

FIGS. 1A and 1B depicted a schematic illustration of an example of the impact of propagation delay on the receiving of the data transmitted by the users over timeslots with a shared guard time. In these examples each sub-channel was used simultaneously by a single user only. The system and method for transmitting data in a wireless communication network can also support users transmitting data over timeslots with a shared guard time with two or more users using a given sub-channel of the timeslot simultaneously. FIG. 1C depicts a schematic illustration of an example of users transmitting data over timeslots with a shared guard time with two or more users using a given sub-channel of the timeslot simultaneously, in accordance with the presently disclosed subject matter. In these cases, the system and method for transmitting data in a wireless communication network assures that a first user that used a given sub-channel of a given timeslot simultaneously with a second user will collide with a different user, different from the second user, when transmitting in subsequent timeslots. This allows the non-orthogonal access method to better separate superimposing signals from the two or more users transmitting simultaneously in the given sub-channel, as power differences between the transmitted signals are used to separate the superimposing signals and ensuring different colliding users on subsequent timeslots warrants power differences. In the non-limiting example depicted in FIG. 1C, timeslot A 100-a is transmitted over a first frequency channel having frequency A 140-a. Timeslot A 100-a comprises three orthogonal sub-channels: sub-channel A 130-a, sub-channel B 130-b and sub-channel C 130-c. Timeslot A 100-a is shared between four users in this example: user A 120-a, user B 120-b, user C 120-c and user D 120-d. The four users share the same timeslot by each pair of users using one of the sub-channels simultaneously: user A 120-a and user B 120-b transmit simultaneously on sub-channel A 130-a and user C 120-c and user D 120-d transmit simultaneously on sub-channel B 130-b. The last sub-channel of timeslot A 100-a is sub-channel C 130-c and it is used for guard time A 110-a. Guard time A 110-a is shared and used commonly by the four users: user A 120-a, user B 120-b, user C 120-c and user D 120-d. FIG. 1C, also depicts a subsequent timeslot B 100-b, subsequent to timeslot A 100-a, that is transmitted over a second frequency channel having frequency B 140-b. Timeslot B 100-b comprises three orthogonal sub-channels: sub-channel D 130-d, sub-channel E 130-e and sub-channel F 130-f. Timeslot B 100-b is shared between the same four users of our example: user A 120-a, user B 120-b, user C 120-c and user D 120-d. The four users share the same timeslot by each pair using one of the sub-channels simultaneously. The system and method for transmitting data in a wireless communication network assures that a first user that used a given sub-channel of a given timeslot simultaneously with a second user will collide with a different user, different from the second user, when transmitting in subsequent timeslots. In our non-limiting example, user A 120-a transmitted simultaneously with user B 120-b in sub-channel A 130-a of timeslot A 100-a, therefore in sub-channel D 130-d of timeslot B 100-b, user A 120-a will transmit simultaneously with user D 120-d. User C 120-c transmitted simultaneously with user D 120-d in sub-channel B 130-b of timeslot A 100-a, therefore in sub-channel E 130-e of timeslot B 100-b, user C 120-c will transmit simultaneously with user B 120-b.

FIG. 1D depicts a schematic illustration of an example of the impact of propagation delay on the receiving of the data transmitted by the users over timeslots with a shared guard time where two or more users are using a given sub-channel of the timeslot simultaneously, in accordance with the presently disclosed subject matter. FIG. 1D continues our non-limiting example of FIG. 1C, it shows how propagation delay causes a receiving user to receive the signal transmitted by user A 120-a, user B 120-b, user C 120-c and user D 120-d after a delay. The delay causing one or more of the sub-channels of the given timeslot to at least partly superimpose. In our example, the propagation delay caused the data that user A 120-a transmitted within sub-channel A 130-a of timeslot A 100-a to superimpose on the data transmitted by user C 120-c within sub-channel B 130-b of timeslot A 100-a, thereby creating a part of timeslot A 100-a that contains signals from both user A 120-a and user C 120-c. This part is labeled superimposing sub-channels C 150-c. The propagation delay also caused the data that user B 120-b transmitted within sub-channel A 130-a of timeslot A 100-a to superimpose on the data transmitted by user D 120-d within sub-channel B 130-b of timeslot A 100-a, thereby creating a part of timeslot A 100-a that contains signals from both user B 120-b and user D 120-d. This part is labeled superimposing sub-channels D 150-d. In the same example, the propagation delay has also caused the data that user A 120-a transmitted within sub-channel D 130-d of timeslot B 100-b to superimpose on the data that user C 120-c transmitted within sub-channel E 130-e of timeslot B 100-b, thereby creating a part of timeslot B 100-b that contains signals from user A 120-a and user C 120-c that superimpose. This part is labeled superimposing sub-channels E 150-e. The propagation delay has also caused the data that user B 120-b transmitted within sub-channel E 130-e of timeslot B 100-b to superimpose on the sub-channel F 130-f, thereby creating a part of timeslot B 100-b that contains signals from user B 120-b and guard time B 110-b that superimpose. This part is labeled superimposing sub-channels F 150-f. The superimposing sub-channels (for example: superimposing sub-channels C 150-c, superimposing sub-channels D 150-d, superimposing sub-channels E 150-e and superimposing sub-channels F 150-f) are separated by using the guard time sub-channel and utilizing a non-orthogonal access method. The non-orthogonal access method is also used by the receiver to separate the two or more users that transmit simultaneously within a given sub-channel. The system and method for transmitting data in a wireless communication network assures that a first user that used a given sub-channel of a given timeslot simultaneously with a second user will collide with a different user, different from the second user, when transmitting in subsequent timeslots. This allows the non-orthogonal access method to better separate superimposing signals from the two or more users transmitting simultaneously in the given sub-channel, as power differences between the transmitted signals are used to separate the superimposing signals and ensuring different colliding users on subsequent timeslots warrants power differences.

It is to be noted, that when looking at the overall effect of the system and method for transmitting data in a wireless communication network described herein, the utilization of the guard times and the non-orthogonal access method to separate superimposing signals allow for a communication network wherein the transmitters transmit in a given frequency hopping rate and wherein the actual frequency hopping rate over the air is faster than the given frequency hopping rate. During the time window that a receiver receives a single hop (or a single timeslot), that receiver actually receives over the air signals from multiple transmitters thereby generating a faster frequency hopping rate without upgrading the hardware of the transmitters or the receivers.

In another embodiment, the communication network can have no guard times and no frequency hopping. In this embodiment, the users (for example: user A 120-a, user B 120-b) access the communication network to transmit data to the network and/or receive data from the network in the same frequency. Transmitting of the data over the communication network is done through a sequence of a predetermined number of timeslots (e.g., timeslot A 160-a, timeslot B 160-b, . . . , timeslot N 160-n), these timeslots are not divided into sub-channels, utilizing a time-division access method, such as: Time-Division Multiple Access (TDMA) access method. The receiving users utilize a Non-Orthogonal Multiple Access (NOMA) method to separate signals from transmitters that collide in time, for example, because of propagation delay.

Bearing this in mind, attention is drawn to FIG. 1E, a schematic illustration of an example of users transmitting data over timeslots with a no guard time and no frequency hopping, in accordance with the presently disclosed subject matter.

Users (for example: user A 120-a, user B 120-b) of a communication network, having one or more frequency channels each having a given frequency (for example: frequency A 140-a), can share a given frequency channel by dividing the signal into different timeslots (e.g., timeslot A 160-a, timeslot B 160-b, . . . , timeslot N 100-n). For example, by using the Time-division multiple access (TDMA) channel access method. The timeslots of the given frequency channel can be sequenced in a predetermined number of timeslots.

The communication network can be a radio communication network, where the users transmit and/or receive radio signals. A user can be any device (for example, a transmitter, a receiver, a transceiver, a computerized device with a network interface, etc.) that can transmit and/or receive radio signals from and to the communication network. The radio signals transmitted and/or received can contain voice, video, data or any other information the user transmits or receives from the network.

One of the challenges of communication networks is propagation delay—the amount of time it takes for the radio signal to travel from the location of the transmitting user to the location of the receiving user. Propagation delay can be computed as the ratio between the link length and the propagation speed over the specific medium. As a result of the distance between the location of the transmitting user to the location of the receiving user, propagation delay causes a signal transmitted in a given timeslot signal to overflow and be received by the receiving user as at least partly superimposing on a subsequent timeslot. In the non-limiting example depicted in FIG. 1E, user A 120-a is using timeslot A 160-a, which is transmitted over a first frequency channel having frequency A 140-a. FIG. 1E, also depicts a subsequent timeslot B 160-b, subsequent to timeslot A 160-a, that is transmitted over the same frequency channel having frequency A 140-a. Timeslot B 160-b is used by user B 120-b.

FIG. 1F depicts a schematic illustration of an example of the impact of propagation delay on the receiving of the data transmitted by the users over timeslots with a no guard time and no frequency hopping, in accordance with the presently disclosed subject matter. FIG. 1F continues our non-limiting example from FIG. 1E, it shows how propagation delay causes a receiving user to receive the signal transmitted by user A 120-a and user B 120-b after a delay. The delay causing one or more of the timeslots to at least partly superimpose. In our example, the propagation delay caused timeslot A 160-a to superimpose on timeslot B 160-b, thereby creating a part of timeslot B 160-b that contains signals from both user A 120-a and user B 120-b. This part is labeled superimposing timeslots A 170-a. The superimposing timeslots (for example: superimposing timeslots A 170-a) can be separated back into the original sent signals by utilizing a non-orthogonal access method. In our example, superimposing timeslots A 170-a contains data transmitted by user A 120-a and user B 120-b. The separation of that superimposing radio signals is achieved utilizing a non-orthogonal access method. An example of a non-orthogonal access method is Non-Orthogonal Multiple Access (NOMA) method. NOMA uses superposition coding at the transmitter side and a decoding method at the receiver side, for example: Multi-User Joint Decoding or Successive Interference Cancellation (SIC) at the receiver side to allow multiple users to utilize the same frequency of the communication network. At the transmitting sites (the signal can originate from two or more different transmitters), the users' signals are superimposed into a single waveform, while at the receiver, SIC decodes the signals one by one until it finds the desired signal. The first signal that SIC decodes has the strongest power while others are viewed temporarily as interferences. In SIC, for example, the first decoded signal is then subtracted from the received signal and if the decoding is perfect, the waveform with the rest of the signals is accurately obtained. SIC iterates the process until it finds the desired signal. It is to ne noted that in some cases two or more of the received signals can have the same or similar power level. In these cases, one of the received signals with the same or similar power level can be decoded together or before the others. Examples of such algorithms are: Multi users Joint Decoding and Message Passage Algorithm (MPA).

Having briefly described an example of users transmitting data over timeslots with a shared guard time and with no guard times, attention is drawn to FIG. 2, a block diagram schematically illustrating one example of a system for transmitting data in a wireless communication network, in accordance with the presently disclosed subject matter.

System 200 (interchangeably called herein “system for transmitting data in a wireless communication network”) can be part of one or more devices connected to the communication network. In some cases, system 200 is installed on all communication devices connected to the network to control their access to the network. In other cases, the system 200 is installed on some of the devices and at least some of the devices are controlled remotely by system 200 to determine their access to the network

System 200 can comprise or be otherwise associated with a data repository 210 (e.g., a database, a storage system, a memory including Read Only Memory—ROM, Random Access Memory—RAM, or any other type of memory, etc.) configured to store data, including, inter alia, frequencies (for example: frequency A 140-a, frequency B 140-b), frequency hopping sequences, divisions of timeslots into sub-channels, etc. In some cases, data repository 210 can be further configured to enable retrieval and/or update and/or deletion of the data stored thereon. It is to be noted that in some cases, data repository 210 can be local and in other cases it can be distributed. It is to be noted that in some cases, data repository 210 can be stored in on cloud-based storage.

System 200 can further comprise a network interface 220 enabling connecting the system 200 to the communication network and enabling it to send and receive data, such as radio signals, sent by the user through his network device, including in some cases receiving one or more superimposing sub-channels (for example: superimposing sub-channels A 150-a, superimposing sub-channels B 150-b). In some cases, the network interface 220 can be connected to a Local Area Network (LAN), to a Wide Area Network (WAN), or to the Internet. In some cases, the network interface 220 can connect to a wireless network.

System 200 further comprises processing circuitry 230. Processing circuitry 230 can be one or more processing circuitry units (e.g., central processing units), microprocessors, microcontrollers (e.g., microcontroller units (MCUs)) or any other computing devices or modules, including multiple and/or parallel and/or distributed processing circuitry units, which are adapted to independently or cooperatively process data for controlling relevant system 200 resources and for enabling operations related to system 200 resources.

The processing circuitry 230 comprises the following module: network access module 240.

Network access module 240 can be configured to perform one or more of: a network access process, as further detailed herein, inter alia with reference to FIG. 3, or a no guard time network access process, as further detailed herein, inter alia with reference to FIG. 4.

FIG. 3 is a flowchart illustrating one example of a sequence of operations carried out for transmitting data in a wireless communication network with shared guard times, in accordance with the presently disclosed subject matter.

According to certain examples of the presently disclosed subject matter, system 200 can be configured to perform a network access process 300, e.g., utilizing the network access module 240, including activities for managing the access of multiple users (for example: user A 120-a, user B 120-b, user C 120-c, user D 120-d) to a communication network. The users can transmit data to the network and/or receive data from the network. Transmitting of the data over the communication network is done through a sequence of a predetermined number of timeslots (e.g., timeslot A 100-a, timeslot B 100-b, . . . , timeslot N 100-n) comprising of mostly orthogonal sub-channels (for example: superimposing sub-channels A 150-a, superimposing sub-channels B 150-b) and a guard time (e.g., guard time A 110-a, guard time B 110-b, . . . , guard time N 110-n) utilizing a time-division access method, such as: Time-Division Multiple Access (TDMA) access method. The receiving users utilize a Non-Orthogonal Multiple Access (NOMA) method to separate signals from transmitters that collide in time, for example, because of propagation delay. For this purpose, system 200 can be configured to transmit data over at least one radio frequency channel in a sequence of a predetermined number of timeslots, wherein: (a) two or more users of the network share the given radio frequency channel and a given timeslot, (b) the data from the users is transmitted in the network using frequency hopping in which each of the users has a frequency hopping sequence, (c) the data of each user sharing the given timeslot in the given radio frequency channel is transmitted in a sub-channel of the given timeslot that is substantially orthogonal to other sub-channels of the given timeslot, and (d) the given timeslot includes a guard time sub-channel that is: (i) substantially orthogonal to other sub-channels of the given timeslot, (ii) located at the end of the given timeslot, (ii) not used to transmit the data from the users, and (iv) shared between the users, thereby enabling a receiver, receiving the data transmitted over the at least one radio frequency channel after propagation delay causing one or more of the sub-channels of the given timeslot to at least partly superimpose, to separate the one or more at least partly superimposed sub-channels by using the guard time sub-channel and utilizing a non-orthogonal access method (block 310). In some case, each of the users is associated with a distinct frequency hopping sequence. It is to be noted that system 200 can allocate different transmission times to different users, for example: in accordance with the transmission history of the user. The length of a message of data that users are transmitting can be unequal between users. Not all users transmit at each timeslot. In a group of frequency hopping transmissions, the messages of data that users are transmitting are within the group and the messages of the group are received and decoded together. In some cases, no frequency hopping is applied, in these cases, in each timeslot only one user is transmitting simultaneously and no guard time is required. The non-orthogonal access method can be a Non-Orthogonal Multiple Access (NOMA) method

In some cases, two or more users share a given sub-channel simultaneously. System 200 requires a power difference between the data transmitted simultaneously in order for non-orthogonal access method can work in separating colliding signals from multiple users. System 200 will, in these cases, ensure the power difference by making a first user collide with different users in each timeslot. In these cases, the transmitting of the data over at least one radio frequency channel in a sequence of a predetermined number of timeslots, is performed by system 200 wherein: (a) a first sub-channel of the sub-channels of the given timeslot in the given radio frequency channel is used simultaneously to transmit data of two or more first sharing users of the users, and (b) a second sub-channel of the sub-channels of the given timeslot in the given radio frequency channel is used simultaneously to transmit data of two or more second sharing users of the users (block 320).

Upon the first sharing users and the second sharing users transmitting data in a second timeslot in a second radio frequency channel, subsequent to the given timeslot, a third sub-channel of the sub-channels of the second timeslot is used at the same time to transmit data of two or more third sharing users of the or more users, and a fourth sub-channel of the sub-channels of the second timeslot is used at the same time to transmit data of two or more fourth sharing users of the users, wherein the third sharing users comprises at least a first user from the first sharing users and a first user from the second sharing users and the fourth sharing users comprises at least a second user from the first sharing users and a second user from the second sharing users (block 330). It is noted that the frequency of the given radio frequency channel can be different from the frequency of the second radio frequency channel.

In some cases, system 200 can be part of a radio communication device comprising a transmitter, transmitting in accordance with network access process 300.

In some cases, system 200 can be part of a radio communication device comprising a receiver, capable of receiving data transmitted in accordance with network access process 300.

In some cases, system 200 can be part of a controlling device, controlling the access of one or more devices to and/or from the communication network in accordance with network access process 300.

In some cases, system 200 can be part of a radio communication device, controlling the access of the radio communication device and the access of additional one or more radio communication devices to and/or from the communication network in accordance with network access process 300.

It is to be noted that, with reference to FIG. 3, some of the blocks can be integrated into a consolidated block or can be broken down to a few blocks and/or other blocks may be added. Furthermore, in some cases, the blocks can be performed in a different order than described herein. It is to be further noted that some of the blocks are optional. It should be also noted that whilst the flow diagram is described also with reference to the system elements that realizes them, this is by no means binding, and the blocks can be performed by elements other than those described herein.

FIG. 4 is a flowchart illustrating one example of a sequence of operations carried out for transmitting data in a wireless communication network with no guard times, in accordance with the presently disclosed subject matter.

According to certain examples of the presently disclosed subject matter, system 200 can be configured to perform a no guard times network access process 400, e.g., utilizing the network access module 240, including activities for managing the access of multiple users (for example: user A 120-a, user B 120-b) to a communication network. The users can transmit data to the network and/or receive data from the network. Transmitting of the data over the communication network is done through a sequence of a predetermined number of timeslots (e.g., timeslot A 160-a, timeslot B 160-b, . . . , timeslot N 160-n) utilizing a time-division access method, such as: Time-Division Multiple Access (TDMA) access method. The receiving users utilize a Non-Orthogonal Multiple Access (NOMA) method to separate signals from transmitters that collide in time, for example, because of propagation delay. For this purpose, system 200 can be configured to transmit the data over the at least one radio frequency channel in a sequence of a predetermined number of timeslots, wherein: (a) a first user of the network transmits data using a first timeslot, and (b) a second user of the network transmits data using a second timeslot, wherein the second timeslot is subsequent to the first timeslot, thereby enabling a receiver, receiving the data transmitted over the at least one radio frequency channel after propagation delay causing the first timeslot to at least partly superimpose on the second timeslot, to separate the at least partly superimposed timeslots by utilizing a non-orthogonal access method (block 410). There are no guard times and no frequency hopping sequences in this embodiment of system 200. It is to be noted that system 200 can allocate different transmission times to different users, for example: in accordance with the transmission history of the user. The length of a message of data that users are transmitting can be unequal between users. Not all users transmit at each timeslot. The non-orthogonal access method can be a Non-Orthogonal Multiple Access (NOMA) method

In some cases, system 200 can be part of a radio communication device comprising a transmitter, transmitting in accordance with no guard times network access process 400.

In some cases, system 200 can be part of a radio communication device comprising a receiver, capable of receiving data transmitted in accordance with no guard times network access process 400.

In some cases, system 200 can be part of a controlling device, controlling the access of one or more devices to and/or from the communication network in accordance with network access process 300.

In some cases, system 200 can be part of a radio communication device, controlling the access of the radio communication device and the access of additional one or more radio communication devices to and/or from the communication network in accordance with no guard times network access process 400.

It is to be noted that, with reference to FIG. 4, some of the blocks can be integrated into a consolidated block or can be broken down to a few blocks and/or other blocks may be added. Furthermore, in some cases, the blocks can be performed in a different order than described herein. It is to be further noted that some of the blocks are optional. It should be also noted that whilst the flow diagram is described also with reference to the system elements that realizes them, this is by no means binding, and the blocks can be performed by elements other than those described herein.

It is to be understood that the presently disclosed subject matter is not limited in its application to the details set forth in the description contained herein or illustrated in the drawings. The presently disclosed subject matter is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the present presently disclosed subject matter.

It will also be understood that the system according to the presently disclosed subject matter can be implemented, at least partly, as a suitably programmed computer. Likewise, the presently disclosed subject matter contemplates a computer program being readable by a computer for executing the disclosed method. The presently disclosed subject matter further contemplates a machine-readable memory tangibly embodying a program of instructions executable by the machine for executing the disclosed method.

1. A method for transmitting data in a wireless communication network with at least one radio frequency channel, the method comprising:
transmitting the data over the at least one radio frequency channel in a sequence of a predetermined number of timeslots, wherein: (a) two or more users of the network share the given radio frequency channel and a given timeslot, (b) the data from the users is transmitted in the network using frequency hopping in which each of the users has a frequency hopping sequence, (c) the data of each user sharing the given timeslot in the given radio frequency channel is transmitted in a sub-channel of the given timeslot that is substantially orthogonal to other sub-channels of the given timeslot, and (d) the given timeslot includes a guard time sub-channel that is: (i) substantially orthogonal to other sub-channels of the given timeslot, (ii) located at the end of the given timeslot, (iii) not used to transmit the data from the users, and (iv) shared between the users, thereby enabling a receiver, receiving the data transmitted over the at least one radio frequency channel after propagation delay causing one or more of the sub-channels of the given timeslot to at least partly superimpose, to separate the one or more at least partly superimposed sub-channels by using the guard time sub-channel and utilizing a non-orthogonal access method.

2. The method of claim 1,
wherein: (a) a first sub-channel of the sub-channels of the given timeslot in the given radio frequency channel is used simultaneously to transmit data of two or more first sharing users of the users, and (b) a second sub-channel of the sub-channels of the given timeslot in the given radio frequency channel is used simultaneously to transmit data of two or more second sharing users of the users; and
upon the first sharing users and the second sharing users transmitting data in a second timeslot in a second radio frequency channel, subsequent to the given timeslot, a third sub-channel of the sub-channels of the second timeslot is used at the same time to transmit data of two or more third sharing users of the or more users, and a fourth sub-channel of the sub-channels of the second timeslot is used at the same time to transmit data of two or more fourth sharing users of the users, wherein the third sharing users comprises at least a first user from the first sharing users and a first user from the second sharing users and the fourth sharing users comprises at least a second user from the first sharing users and a second user from the second sharing users.

3. The method of claim 2, wherein the frequency of the given radio frequency channel is different from the frequency of the second radio frequency channel.

4. The method of claim 1, wherein the non-orthogonal access method is a Non-Orthogonal Multiple Access (NOMA) method.

5. The method of claim 1, wherein the transmitting of the data over the at least one radio frequency channel in a sequence of a predetermined number of timeslots utilizes the Time-Division Multiple Access (TDMA) channel access method.

6. The method of claim 1, wherein each of the users is associated with a distinct frequency hopping sequence.

7. A radio communication device comprising a transmitter, capable of transmitting data in accordance with the method of claim 1.

8. A radio communication device comprising a receiver, capable of receiving data transmitted in accordance with the method of claim 1.

9. A method for transmitting data in a wireless communication network with at least one radio frequency channel, the method comprising:
transmitting the data over the at least one radio frequency channel in a sequence of a predetermined number of timeslots, wherein: (a) a first user of the network transmits data using a first timeslot, and (b) a second user of the network transmits data using a second timeslot, wherein the second timeslot is subsequent to the first timeslot, thereby enabling a receiver, receiving the data transmitted over the at least one radio frequency channel after propagation delay causing the first timeslot to at least partly superimpose on the second timeslot, to separate the at least partly superimposed timeslots by utilizing a non-orthogonal access method.

10. The method of claim 9, wherein the non-orthogonal access method is a Non-Orthogonal Multiple Access (NOMA) method.

11. The method of claim 9, wherein the transmitting of the data over the at least one radio frequency channel in a sequence of a predetermined number of timeslots utilizes the Time-Division Multiple Access (TDMA) channel access method.

12. A radio communication device comprising a transmitter, capable of transmitting data in accordance with the method of claim 9.

13. A radio communication device comprising a receiver, capable of receiving data transmitted in accordance with the method of claim 9.

14. A system for transmitting data in a wireless communication network with at least one radio frequency channel, the system comprising a processing circuitry configured to:
transmit the data over the at least one radio frequency channel in a sequence of a predetermined number of timeslots, wherein: (a) two or more users of the network share the given radio frequency channel and a given timeslot, (b) the data from the users is transmitted in the network using frequency hopping in which each of the users has a frequency hopping sequence, (c) the data of each user sharing the given timeslot in the given radio frequency channel is transmitted in a sub-channel of the given timeslot that is substantially orthogonal to other sub-channels of the given timeslot, and (d) the given timeslot includes a guard time sub-channel that is: (i) substantially orthogonal to other sub-channels of the given timeslot, (ii) located at the end of the given timeslot, (iii) not used to transmit the data from the users, and (iv) shared between the users, thereby enabling a receiver, receiving the data transmitted over the at least one radio frequency channel after propagation delay causing one or more of the sub-channels of the given timeslot to at least partly superimpose, to separate the one or more at least partly superimposed sub-channels by using the guard time sub-channel and utilizing a non-orthogonal access method.

15. The system of claim 14,
wherein: (a) a first sub-channel of the sub-channels of the given timeslot in the given radio frequency channel is used simultaneously to transmit data of two or more first sharing users of the users, and (b) a second sub-channel of the sub-channels of the given timeslot in the given radio frequency channel is used simultaneously to transmit data of two or more second sharing users of the users; and
upon the first sharing users and the second sharing users transmitting data in a second timeslot in a second radio frequency channel, subsequent to the given timeslot, a third sub-channel of the sub-channels of the second timeslot is used at the same time to transmit data of two or more third sharing users of the or more users, and a fourth sub-channel of the sub-channels of the second timeslot is used at the same time to transmit data of two or more fourth sharing users of the users, wherein the third sharing users comprises at least a first user from the first sharing users and a first user from the second sharing users and the fourth sharing users comprises at least a second user from the first sharing users and a second user from the second sharing users.

16. The system of claim 15, wherein the frequency of the given radio frequency channel is different from the frequency of the second radio frequency channel.

17. The system of claim 14, wherein the non-orthogonal access method is a Non-Orthogonal Multiple Access (NOMA) method.

18. The system of claim 14, wherein the transmitting of the data over the at least one radio frequency channel in a sequence of a predetermined number of timeslots utilizes the Time-Division Multiple Access (TDMA) channel access method.

19. The system of claim 14, wherein each of the users is associated with a distinct frequency hopping sequence.

20. A non-transitory computer readable storage medium having computer readable program code embodied therewith, the computer readable program code, executable by at least one processing circuitry of a computer to perform a method for transmitting data in a wireless communication network with at least one radio frequency channel, the method comprising:
transmitting the data over the at least one radio frequency channel in a sequence of a predetermined number of timeslots, wherein: (a) two or more users of the network share the given radio frequency channel and a given timeslot, (b) the data from the users is transmitted in the network using frequency hopping in which each of the users has a frequency hopping sequence, (c) the data of each user sharing the given timeslot in the given radio frequency channel is transmitted in a sub-channel of the given timeslot that is substantially orthogonal to other sub-channels of the given timeslot, and (d) the given timeslot includes a guard time sub-channel that is: (i) substantially orthogonal to other sub-channels of the given timeslot, (ii) located at the end of the given timeslot, (iii) not used to transmit the data from the users, and (iv) shared between the users, thereby enabling a receiver, receiving the data transmitted over the at least one radio frequency channel after propagation delay causing one or more of the sub-channels of the given timeslot to at least partly superimpose, to separate the one or more at least partly superimposed sub-channels by using the guard time sub-channel and utilizing a non-orthogonal access method.
